(19) United States
(12) Patent Application Publication
(10) Pub. No.: US 2005/0041125 A1
(43) Pub. Date: Feb. 24, 2005

(54) Imaging device and particle image capturing apparatus using imaging device

(75) Inventor: Hideo Kusuzawa, Kobe-shi (JP)

Correspondence Address: BRINKS HOFER GILSON & LIONE, P.O. BOX 10395, CHICAGO, IL, 60610, US

(73) Assignee: Sysmex Corporation

(21) Appl. No.: 10/922,415

(22) Filed: Aug. 17, 2004

(30) Foreign Application Priority Data
Aug. 21, 2003 (JP) 2003-297875

(51) Int. Cl. H04N 5/335

(52) U.S. Cl. 348/296

(57) ABSTRACT

The present invention relates to an imaging device comprising a plurality of two-dimensional image sensing elements, optical system for forming optical images on the respective image sensing elements and drive control means for driving the plurality of image sensing elements with respectively different timings, and controlling the operation of shutters of the respective image sensing elements so as to expose one image sensing element among the plurality of image sensing elements.

### BACKGROUND OF THE INVENTION

1. Field of the Invention

The present invention relates to an imaging device for imaging an object using two-dimensional imaging elements. Furthermore, the present invention relates to a particle image capturing apparatus for imaging particles in an optical cell moving at high speed together with the medium.

2. Description of the Related Art

Conventional an imaging devices are known, such as digital cameras and the like, which capture the image of an object using an area sensor (two-dimensional imaging element such as a CCD or the like) to produce image data. U.S. Pat. No. 5,721,433 discloses a particle image analyzer capable of analyzing particle images obtained by sequentially imaging particles of a particle suspension fluid flowing within an optical gel and moving through an imaging region, and displaying a calculated distribution map of the shape parameters such as the degree of roundness and the like so as to analyze the shape and the like of micro particles.

When interlace-type CCD area sensors for sequentially scanning odd pixels (ODD field) and even pixels (EVEN field) are used as the imaging elements of the particle image analyzer of U.S. Pat. No. 5,721,433, a striped pattern is introduced into the image when the area sensor is optically exposed during the EVEN field period. In general, the ODD field period of the area sensor is 1/60 of a second, and the EVEN field period is 1/60 of a second. Accordingly, when the particle image analyzer uses interlace-type CCD area sensors, it is difficult to image particles moving through the imaging region during the imaging intervals since the imaging interval must be approximately 1/30 of a second.

### SUMMARY

The object of one embodiment of the present invention is to provide an imaging device which improves the probability of imaging each object even when imaging a plurality of objects moving at high speed.

The first aspect of the present invention relates to an imaging device comprising: a first two-dimensional image sensing elements; a second two-dimensional image sensing element; an optical system for forming identical optical images on the first and second image sensing elements; a first shutter means for controlled exposure of the first image sensing element from the optical system; a second shutter means for controlled exposure of the second image sensing element from the optical system; and a control means for driving the first image sensing element based on field signals sequentially repeating ODD field period and EVEN field period, driving the second image sensing element based on field signals having a different phase than the first image sensing element, and controlling the operation of the first shutter means and second shutter means so as to expose with light from the optical system an image sensing element having the ODD field period among the first and second image sensing elements.

The second aspect of the present invention relates to an imaging device comprising: a plurality of two-dimensional image sensing elements; an optical system for forming optical images on the respective image sensing elements; and a drive control means for driving the plurality of image sensing elements with respectively different timings, and controlling the operation of electronic shutters of the respective image sensing elements so as to expose one image sensing element among the plurality of image sensing elements.

The third aspect of the present invention relates to a particle image capturing apparatus for imaging particles comprising: a flow cell for forming a flow of a particle suspension; a light source for irradiating the particle suspension flow with light; a first two-dimensional image sensing elements driven based on field signals sequentially repeating the ODD field period and EVEN field period; a second two-dimensional image sensing element driven based on field signals having a phase different than that of the first two-dimensional image sensing element; an optical system for forming identical optical images of the particle suspension flow on the first and second two-dimensional image sensing elements; a first shutter means for exposing the first two-dimensional image sensing element with light from the optical system when the first two-dimensional image sensing element has an ODD filed period; and a second shutter means for exposing the second two-dimensional image sensing element with light from the optical system when the second two-dimensional image sensing element has an ODD filed period.

The fourth aspect of the present invention relates to a particle image capturing apparatus for imaging particles comprising: a flow cell for forming the flow of a particle suspension fluid; a light source for irradiating the particle suspension fluid; a first two-dimensional image sensing element; a second two-dimensional image sensing element; an optical system for forming identical optical images of particles in the particle suspension flow on the first and second particle image sensing elements; a first shutter means for controlled exposure of the first image sensing element from the optical system; a second shutter means for controlled exposure of the second image sensing element from the optical system; and a drive control means for driving the first image sensing element based on field signals sequentially repeating ODD field period and EVEN field period, driving the second image sensing element based on field signals having a different phase than the first image sensing element, and controlling the operation of the first shutter means and second shutter means so as to expose with light from the optical system an image sensing element having the ODD field period among the first and second image sensing elements.

The fifth aspect of the present invention relates to a particle image capturing apparatus comprising: a first two-dimensional image sensing element; a second two-dimensional image sensing element; an optical system for forming identical optical images of the particle on the first and second image sensing elements; and a drive control means for driving the first and second image sensing elements with different timings, and controlling the operation of electronic shutters of the respective image sensing elements so as to expose one or another of the first or second image sensing elements.

### BRIEF DESCRIPTION OF THE DRAWINGS

FIG. 1 shows the structure of an embodiment of an imaging device;

FIG. 2 shows the field signals of a first CCD and a second CCD;

FIG. 3 shows the structure of a particle image capturing apparatus using an embodiment of the imaging device;

FIG. 4 is a control block diagram of the particle image capturing apparatus;

FIG. 5 shows the particle image analyzer using the particle image capturing apparatus;

FIG. 6 is a control block diagram of the particle image analyzer;

FIG. 7 shows the flow of the analysis controls of the particle image analyzer;

FIG. 8 illustrates the calculation of the surface area S and the circumference length L of the particle image;

FIG. 9 shows a second embodiment of the measuring unit of the particle image capturing apparatus;

FIG. 10 shows the optical cell of the measuring unit;

FIG. 11 shows the structure light source unit for zonal light exposure; and

FIG. 12 shows the A-A cross sectional view of FIG. 11.

### DESCRIPTION OF THE PREFERRED EMBODIMENTS

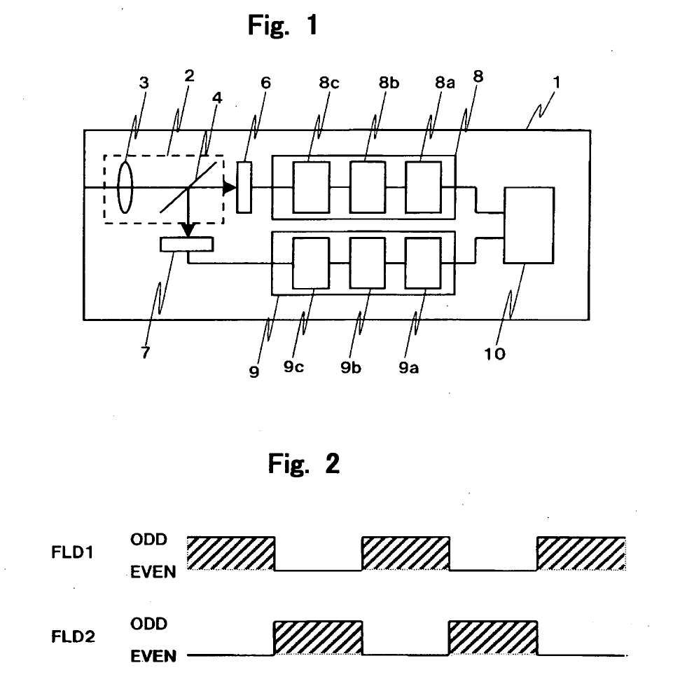

The structure of an embodiment of the imaging device 1 is shown in FIG. 1. The imaging device 1 is provided with an optical system 2, first CCD 6, second CCD 7, a first CCD drive circuit 8 for driving the first CCD, a second CCD drive circuit 9 for driving the second CCD 7, and a standard crystal oscillator 10. The optical system 2 is provided with an objective lens 3 for collecting the image of an object, and a half-mirror 4 for dividing the light from the objective lens 3. The first CCD 6 and the second CCD 7 are both interlace-type CCD area sensors provided with an electronic shutter. The exposure timing of the electronic shutter of the first CCD 6 is controlled by the first CCD drive circuit 8. The exposure timing of the electronic shutter of the second CCD 7 is controlled by the second CCD drive circuit 9.

The first CCD drive circuit 8 for driving the first CCD 6 is provided with a synchronizing signal generator 8a for generating synchronizing signals such as a vertical synchronizing signal VD and horizontal synchronizing signal HD based on the signal of the standard crystal generator 10, timing generator 8b for receiving the input of the vertical synchronizing signal VD and horizontal synchronizing signal HD output from the synchronizing signal generator 8a and generating various types of timing signals used for the first CCD 6, and a driver 8c for receiving the timing signals output from the timing generator 8b and driving the first CCD 6 by providing a vertical transmission pulse, horizontal transmission pulse, and shutter pulses (electronic shutter starting pulse for the first CCD 6) for discharging accumulated signal loads and starting a new exposure. The signal processing system of the output signals of the first CCD 6 are omitted from the drawing. The second CCD drive circuit 9 for driving the second CCD 7 is similarly provided with a synchronizing signal generator 9a for generating synchronizing signals such as a vertical synchronizing signal VD and horizontal synchronizing signal HD, timing generator 9b, and driver 9c.

The first CCD 6 is driven based on the field signal which has the reverse phase of the second CCD 7. In FIG. 2, FLD1 is the field signal for driving the first CCD 6, and FLD2 is the field signal for driving the second CCD 7. FLD1 and FLD2 are field signals which alternatingly repeat the ODD field and EVEN field. The field signal FLD 1 and the field signal FLD2 have the same frequency, and their phase difference is π. The field signal FLD1 has a phase which is the reverse that of the field signal FLD2. Therefore, when the field signal of the first CCD 6 is EVEN, the field signal of the second CCD 7 is ODD, and conversely, when the field signal of the first CCD 6 is ODD, the field signal of the second CCD 7 is EVEN. Either the first CCD 6 or the second CCD 7 are normally in a state capable of image sensing since they are driven by the field signals FLD1 and FLD2.

Although the first CCD 6 and the second CCD 7 are driven based on field signals having reverse phases in the present embodiment, they also may be driven based on field signals having different phases.

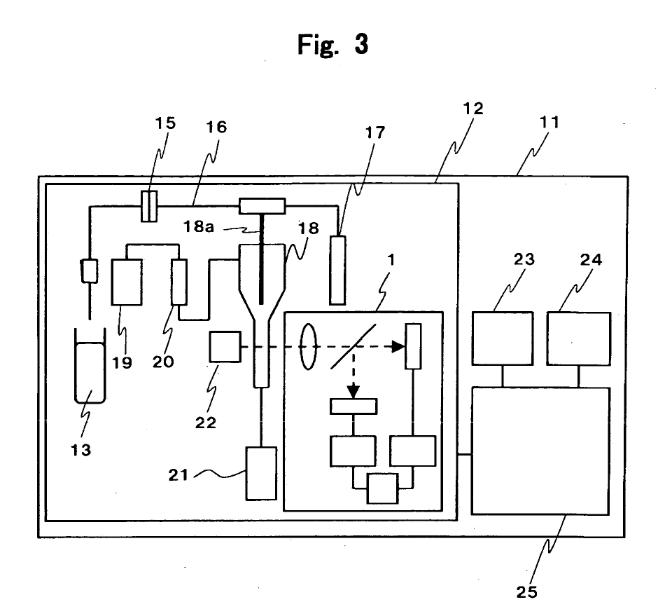

The structure of an embodiment of the particle image capturing apparatus 11 using the imaging device 1 is shown in FIG. 3. The particle image capturing apparatus 11 is provided with a measuring unit 12 provided with the imaging device 1, input unit 23, display unit 24, and control unit 25. The measuring unit 12 is provided with a particle suspension fluid 13 accommodated in a particle suspension bottle, suction pipette 14, sample filter 15, sample charging line 16, sheath syringe 17, flow cell 18, sheath fluid bottle 19, sheath fluid chamber 20, waste fluid chamber 21, light source (strobe) 22, and imaging device 1. The input unit 23 is an input device for performing various types of input operations and command operations, and is a keyboard, mouse and the like. The display unit 24 is a display unit such as a CRT display or the like. A touch panel type display may be used as the input device 23 and the display device 24. Furthermore, since the structure of the imaging device 1 is shown in FIG. 1, the internal structure of the imaging device 1 is omitted from the drawing.

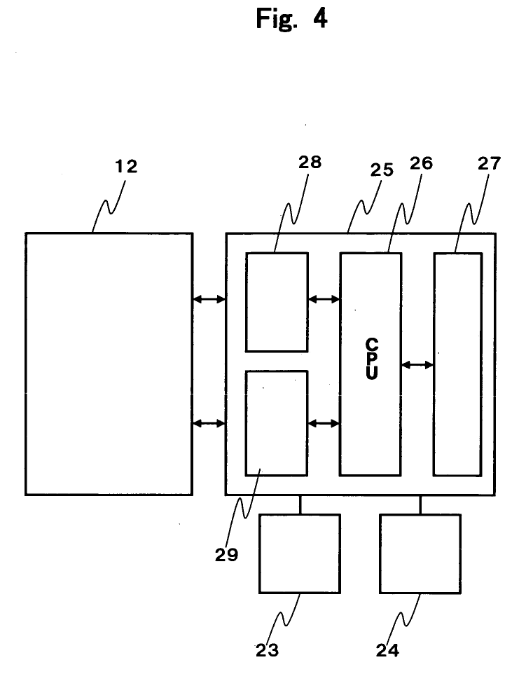

FIG. 4 is a control block diagram of the particle image capturing apparatus 11. The control unit 25 is provided with a central processing unit (CPU) 26, memory 27, measuring unit drive control circuit 28, and signal processing circuit 29. The memory 27 is provided with RAM, ROM, hard disk and the like. The memory 27 accommodates drive control programs for the measuring unit, signal processing programs for processing signals (particle image data) from the first CCD 6 and second CCD 7 and the like. The CPU 26 executes the drive control of the measuring unit through the measuring unit drive control circuit 28 based on the drive control programs accommodated in the memory 27. The CPU 26 processes signals from the first CCD 6 and the second CCD 7 through the signal processing circuit 29 based on the signal processing program accommodated in the memory 27. The particle image data from the first CCD 6 and the second CCD 7 are converted to digital data by an A/D converter of the signal processing circuit 29, and thereafter stored in the memory 27.

The imaging of the particle image in the measuring unit 12 of FIG. 3 is performed as described below. First, the particle suspension fluid 13 accommodated in the particle suspension bottle is suctioned by the suction pipette 14, passed through the sample filter 15, and delivered to the sample charging line 16 at the top part of the flow cell 18. Coarse particles and debris in the suspension fluid are removed by the sample filter 15 so as to not clog the narrow flow cell 18 of the flow path. Furthermore, the sample filter 15 is also effective in unbinding coarse clumps. When the assayed particles are semitransparent, an appropriate staining of the particles may be performed.

The suspension fluid 13 delivered to the charging line 16 is introduced to the flow cell 18 by the operation of the sheath syringe 17, and the particle suspension fluid 13 is extracted a little at a time from the tip of the sample nozzle 18a. At the same time, the sheath fluid is also delivered to the flow cell 18 from the sheath fluid bottle 19 through the sheath fluid chamber 20. As a result, the particle suspension fluid 13 is encapsulated in the sheath fluid, and the suspension fluid is constricted as it flows within the flow cell 18 via flow dynamics, and is discharged to the waste chamber 21.

The suspension flow in the flow cell 18 is periodically irradiated each 1/60 second by a pulse of light from the light source (strobe) 22. In this way a still image of a particle is introduced each 1/60 second to the optical system 2 of the solid-state imaging device 1. The still image is input to the first CCD 6 and second CCD 7 through the optical system 2. The first CCD 6 is driven by a field signal having the reverse phase of the second CCD 7 as described previously. Therefore, the image of the particle input by the optical system 2 is sensed by the CCD which has the ODD field signal among the first CCD 6 and the second CCD 7.

Although a first CCD drive circuit 8 and a second CCD drive circuit 9 are used as exposure control means in the above embodiment, the exposure timing of the first CCD 6 and second CCD 7 also may be controlled by the control unit 25. Furthermore, although an electronic shutter is used as a shutter means for controlling the exposure of the first CCD 6 and second CCD 7, a mechanical shutter also may be used.

Although the first CCD 6 and second CCD 7 are driven based on field signals having reverse phases, they also may be driven based on field signals having different phases.

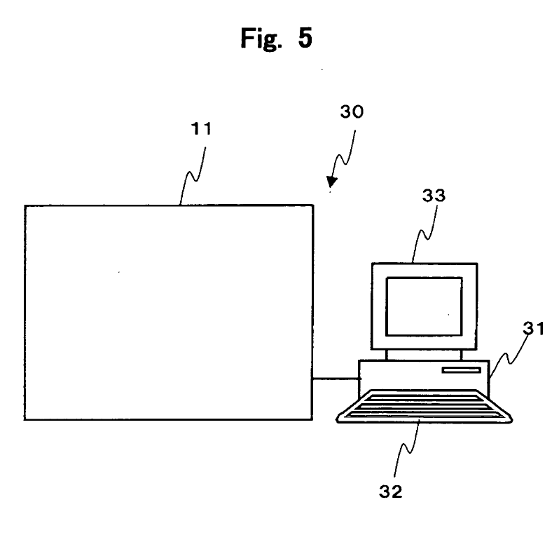

The structure of a particle image analyzer 30 provided with the particle image capturing apparatus 11 is shown in FIG. 5. The particle image analyzer 30 is provided with the particle image capturing apparatus 11, image processing device (personal computer) 31, operation input unit 32 for inputting various types of operations and the like, and display unit 33. The operation input unit 32 is a keyboard (or mouse), and the display unit 33 is a display.

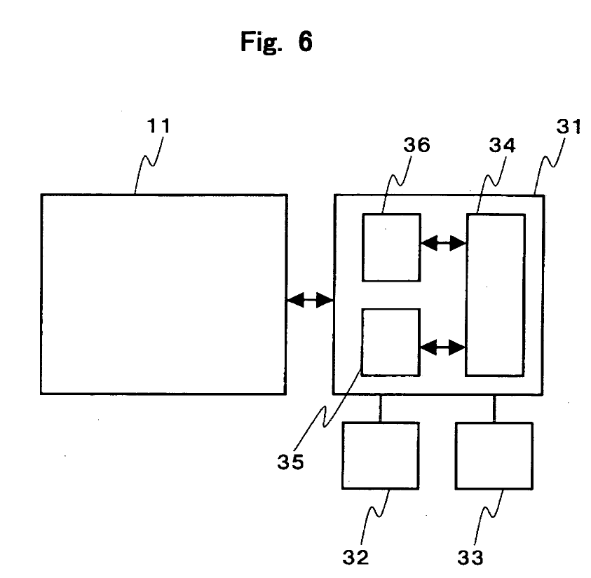

FIG. 6 is a block diagram of the image processing system in the particle image analyzer; the particle image data from the particle image capturing apparatus 11 is processed in the image processing device (personal computer) 31, and displayed on the display 33 (display unit) functioning as a display device. The image processing device 31 is provided with a CPU 34, memory unit 35, and signal processing circuit 36. The memory unit 35 is provided with a RAM, ROM, hard disk and the like, and stores analysis programs for executing the image processes described below.

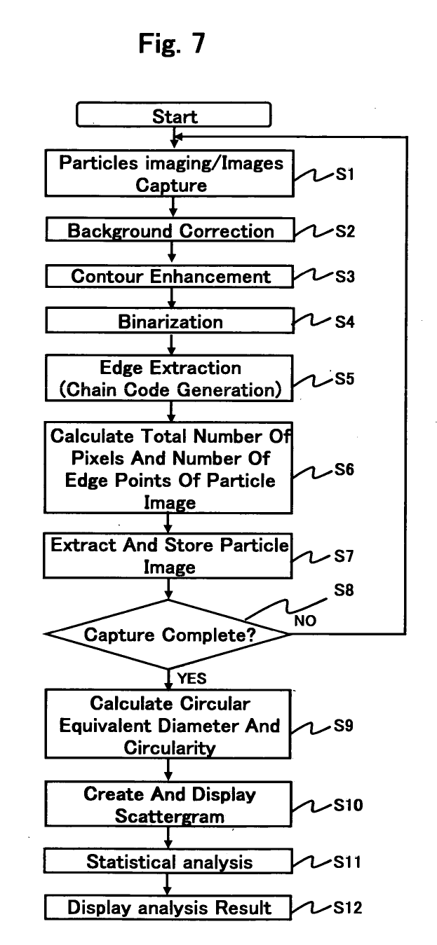

The image processing sequence of particle image data of each 1/60 second is shown in FIG. 7. The image processing device 31 executes the processes of steps S1 through S12 shown in FIG. 7.

The particle image signals from the first CCD 6 and second CCD 7 are subjected to A/D conversion by the signal processing circuit 36 of the image processing device 31, to obtain particle image data (step S1). First, the obtained image data are subjected to background correction to correct unevenness in the intensity of light (shading) irradiating the suspension fluid flow (step S2).

Specifically, image data obtained by light exposure when particles are not moving through the flow cell 18 are collected prior to the measuring, and these image data and the image data of the actual particle image screen are compared. Then, a contour enhancement process is executed to accurately extract the contour of the particle image (step S3). Specifically, the generally well-known Laplacean enhancement process is executed.

Next, the image data are binarized at an appropriate threshold level (step S4). Then, a determination is made as to whether or not the binarized particle image has an edge point, and information on a possible edge point adjacent to the observed edge point. That is, a chain code, is generated (step S5). Thereafter, the particle image is subjected to edge tracing while referring to the chain code, and the total number of pixels, total number of edges, and number of inclined edges of each particle image are determined (step S6).

If an image processing device capable of high-performance pipeline processing is used, the aforesaid image processing of a screen imaged every 1/60 second can be accomplished in real time. Furthermore, the particle image can be extracted from the imaged frame, and the extracted particle image can be stored in the image memory of the memory unit 35 of the image processing device 31 (step S7).

When the imaging ends (step S8), particle characteristics parameters such as circular equivalent diameter (granularity) and roundness and the like are calculated as described below (step S9). First, the projection surface area S and circumferential length L of each particle image are determined from the total number of pixels, total number of edges, and number of inclined edges of each particle image using the equations below.

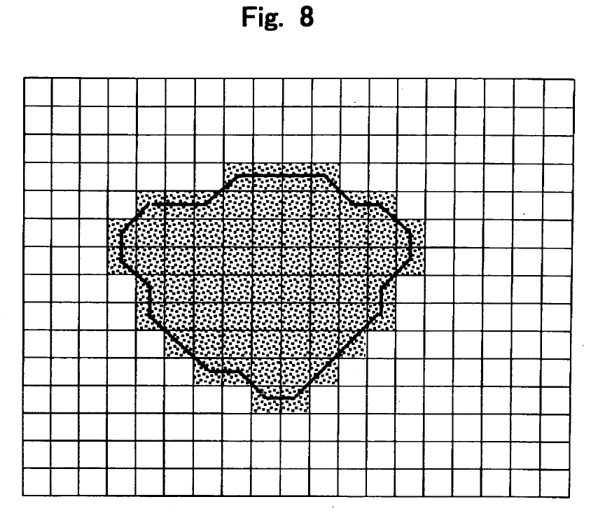

As shown in FIG. 8, the surface area S within the frame and the length of the frame (period length L) which can be connected to the center of the edges of the circumferences of binary images can be expressed by equations (1) and (2) below when the surface area per unit pixel is “1”.
Surface area S=total number of pixels−(total edges×0.5)−1 (1)
Circumferential length L=(total number of edges−number of inclined edges)+(number of inclined edges×2^{1/2}) (2)

Then, the circular equivalent diameter is determined using the surface area S and circumferential length L. The circular equivalent diameter is the diameter of a circle having the same surface area as the projection image of the particle, and is expressed by equation (3). The roundness is a value defined by equation (4); the roundness is “1” when the particle image is circular, and the roundness value becomes smaller the larger the irregularities of the exterior edge of the particle image.
Circular equivalent diameter=(particle projection image area/π)½×2 (3)
Roundness=(circumferential length of a circle having a projection surface area value identical to the particle image)/(circumferential length of the particle image) (4)

When the circular equivalent diameter (granularity) and roundness of each particle image is calculated in this way, then a required scattergram and histogram are created based on commands from the keyboard 32 and displayed on the display 33 (step S10).

When analysis items and analysis regions are specified from the keyboard 32, these items and regions of the displayed scattergram and histogram are analyzed, that is, various analysis data, such as average value, standard deviation, variable coefficient, median value, mode value, 10% cumulative value, 50% cumulative value, 90% cumulative value and the like are calculated and the calculation results are displayed (steps S11, S12).

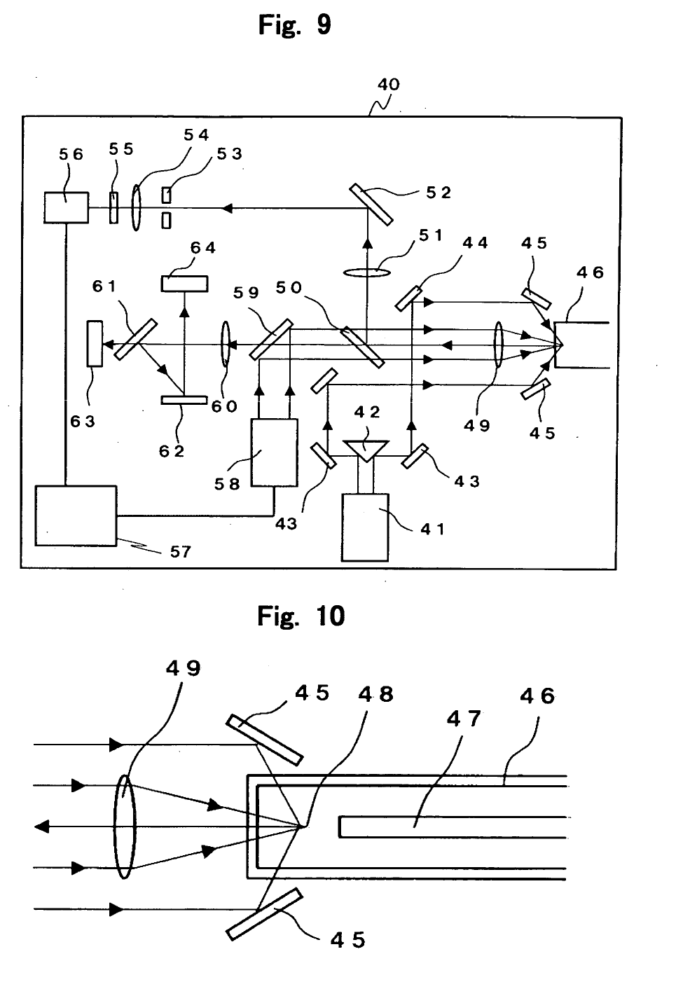

FIG. 9 shows the structure of a second embodiment of the particle image capturing apparatus. FIG. 10 shows details of the optical cell and the particle suspension fluid discharge nozzle of FIG. 9. The first CCD drive circuit for driving the first CCD 6 and the second CCD drive circuit fro driving the second CCD 7 are omitted from FIG. 9 since they are identical to the first CCD drive circuit 8 and second CCD drive circuit 9 of FIG. 1.

The measuring unit 40 is provided with a first light source unit 41 having a red semiconductor laser light source with a wavelength of 660 nm, conical exterior surface reflective mirror 42, conical interior surface reflective mirror 43, ring mirror 44, conical interior surface reflective mirror 45, optical cell 46, objective lens 49, dichroic mirror 50, lens 51, mirror 52, pinhole plate 53, collimator lens 54, bandpass filter 55, photosensor element (photomultiplier tube) 56, imaging control unit 57, second light source unit 58 having a pulse semiconductor light source with a wavelength of 870 nm, half-mirror 59, focusing lens 60, half-mirror 61, mirror 62, first CCD 63, and second CCD 64.

First, when a laser beam of 600 nm wavelength is emitted from the first light source unit 41, the laser light is converted to zonal light by the conical exterior surface reflective mirror 42 and the conical interior surface reflective mirror 43. The zonal light is guided to the conical interior surface reflective mirror 45 by the ring mirror 44, and converges at the detection region 48 of FIG. 10. In FIG. 10, when the particle in the suspension fluid discharged from the nozzle 47 in the optical cell 46 reaches the detection region 48, the particle is excessively irradiated by the 600 nm zonal light. The scattered light (600 nm) from the excessively irradiated particle is reflected by the dichroic mirror 50 through the objective lens 49, and enters the photosensor element (photomultiplier tube) 56 through the lens 5 1, mirror 52, pinhole plate 53, collimator lens 54, and bandpass filter 55. In this way the photosensor element 56 measures the intensity of the scattered light from the detection region 48. When the scattered light from the detection region 48 is detected by the photosensor element 56, the imaging control unit 57 determines the imaging object particle when the scattered light intensity is in a predetermined range, and the pulse semiconductor laser light source (wavelength: 870 nm) of the second light source unit 58 generates a pulse. The pulse semiconductor laser light having a wavelength of 870 nm is reflected by the half-mirror 59. The light reflected by the half-mirror 59 passes through the dichroic mirror 50, and converges at the detection region 48 via the objective lens 49. The dichroic mirror 50 transmits light having a wavelength of 870 nm, and reflects light having a wavelength of 600 nm.

The scattered light from the irradiated particle enters the first CCD 63 through the objective lens 49, dichroic mirror 50, half-mirror 59, objective lens 60, and half-mirror 61. The light reflected by the half-mirror 61 enters the second CCD 64 through the mirror 62. This assay unit 40 is capable of high efficiency imaging of particles since it detects and images particles moving in the imaging region. Although the detection region 48 shown in FIG. 10 is set so as to closely match the imaging region, the imaging region also may be set to the left side of the detection region 48 in FIG. 10 (downstream in the medium discharge direction from the nozzle 47).

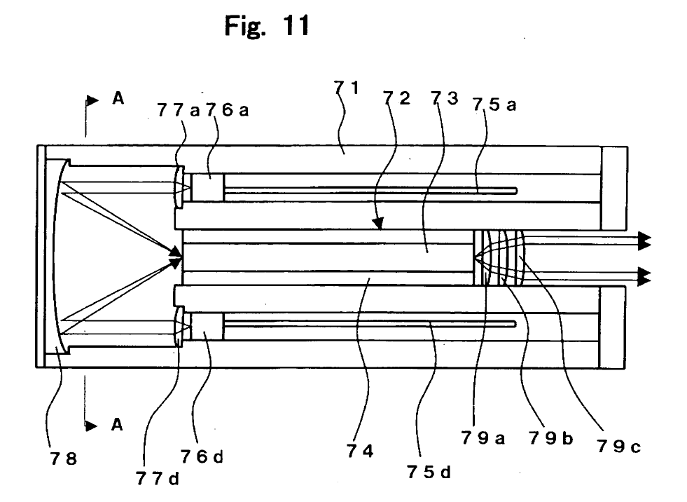

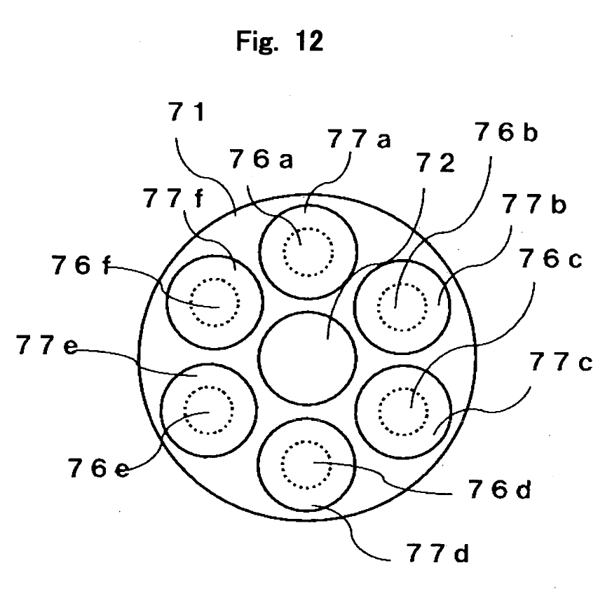

Furthermore, a zonal irradiating light source unit having the structure shown in FIGS. 11 and 12 may be used as the second light source unit 58. FIG. 11 is a cross sectional view of the structure of a zonal irradiation light source unit, and FIG. 12 is an A-A cross sectional view of FIG. 11.

In FIGS. 11 and 12, a multimode optical fiber 72 is inserted into a through-hole provided on the same axis as the center axis of a cylindrical body 71. The multimode optical fiber 72 has a core 73 and clad 74. The body 71 is provided with six through-holes parallel to the through-hole disposed on the same axis as the center axis of the body 71 on the circular circumference centered on the center axis of the body 71, and provided at the end of these respective through-holes are laser light sources 76a, 76b, 76c, 76d, 76e, 76f, and collimator lenses 77a, 77b, 77c, 77d, 77e, and 77f (refer to FIG. 12). inside these through-holes are provided light source drive circuit boards 75a, 75b, 75c, 75d, 75e, and 75f (boards 75b, 75c, 75d, 75e, and 75f are not shown).

The light-emitting sides of the through-holes provided on the same axis as the center axis of the body 71 are provided with three collimator lenses 79a, 79b, and 79c. A concave mirror 78 is provided at the left endface of the body 71 shown in FIG. 11. The optical axis of the multimode optical fiber 72 matches the optical axis of the concave mirror 78, that is, the light receiving opening is arranged at the focus point of the concave mirror 78.

A multimode optical fiber having a core diameter of 800 □m is used as the multimode optical fiber 72. Furthermore, Pulse semiconductor lasers are used as the laser light sources 76a through 76f.

In the aforesaid structure, the plurality of light fluxes emitted from the laser light sources 76a through 76f are converted parallel light which is parallel to the optical axis of the mirror 78 by the collimator lenses 77a through 77f. The parallel light is condensed by the concave mirror 78 and enters the light receiving end of the multimode optical fiber 72 from different directions at predetermined identical entrance angles. Since the length of the optical paths are mutually identical from the laser light sources 76a through 76f to the multimode optical fiber 72, all of the light flux enters the light receiving opening having the same spot diameter.

The multimode optical fiber 72 mixes the plurality of entering light fluxes and reduces the coherence and smoothes the light intensity distribution and emits the radiant zonal light fluxes from the emission opening to the three collimator lenses 79a, 79b, and 79c. The collimator lenses 79a, 79b, and 79c convert the radiant zonal light fluxes from the optical fiber 72 to parallel light flux having a single optical axis.

From the perspective of good zonal light formation, the plurality of laser light sources are arranged on the circumference centered on the optical axis of the multimode optical fiber 72 such that the spacing of the adjacent laser light sources are equidistant. The number of zonal light forming light sources, that is, the laser light sources emitting light of the zonal light wavelength, is desirably four to eight, and preferably 5 to eight.

According to this structure, coherence can be reduced and zonal light effectiveness improved by the multimode optical fiber using a plurality of laser light sources which emit light flux of a predetermined wavelength. That is, when a particle imaged by zonal light is irradiated, optical resolution is improved since only the light flux entering at an angle to the particle is used. Furthermore, the detection signal to noise ratio is improved by using laser light to reduce coherence.

1. An imaging device comprising:
a first two-dimensional image sensing elements;
a second two-dimensional image sensing element;
an optical system for forming identical optical images on the first and second image sensing elements;
a first shutter means for controlled exposure of the first image sensing element from the optical system;
a second shutter means for controlled exposure of the second image sensing element from the optical system; and
a control means for driving the first image sensing element based on field signals sequentially repeating ODD field period and EVEN field period, driving the second image sensing element based on field signals having a different phase than the first image sensing element, and controlling the operation of the first shutter means and second shutter means so as to expose with light from the optical system an image sensing element having the ODD field period among the first and second image sensing elements.

2. The imaging device of claim 1, wherein the first and second shutter means are electronic shutters.

3. The imaging device of claim 1, wherein the drive control means drives the second image sensing element based on field signals having the reverse phase to that of the first image sensing element.

4. An imaging device comprising:
a plurality of two-dimensional image sensing elements;
an optical system for forming optical images on the respective image sensing elements; and
a drive control means for driving the plurality of image sensing elements with respectively different timings, and controlling the operation of electronic shutters of the respective image sensing elements so as to expose one image sensing element among the plurality of image sensing elements.

5. The imaging device of claim 4, wherein the optical system is capable of forming identical optical images on the respective image sensing elements.

6. A particle image capturing apparatus for imaging particles comprising:
a flow cell for forming a flow of a particle suspension;
a light source for irradiating the particle suspension flow with light;
a first two-dimensional image sensing elements driven based on field signals sequentially repeating the ODD field period and EVEN field period;
a second two-dimensional image sensing element driven based on field signals having a phase different than that of the first two-dimensional image sensing element;
an optical system for forming identical optical images of the particle suspension flow on the first and second two-dimensional image sensing elements;
a first shutter means for exposing the first two-dimensional image sensing element with light from the optical system when the first two-dimensional image sensing element has an ODD filed period; and
a second shutter means for exposing the second two-dimensional image sensing element with light from the optical system when the second two-dimensional image sensing element has an ODD filed period.

7. The particle image capturing apparatus of claim 6, wherein the second two-dimensional image sensing element is driven based on field signal which has the reverse phase of the first two-dimensional image sensing element.

8. A particle image capturing apparatus for imaging particles comprising:
a flow cell for forming the flow of a particle suspension fluid;
a light source for irradiating the particle suspension fluid;
a first two-dimensional image sensing element;
a second two-dimensional image sensing element;
an optical system for forming identical optical images of particles in the particle suspension flow on the first and second particle image sensing elements;
a first shutter means for controlled exposure of the first image sensing element from the optical system;
a second shutter means for controlled exposure of the second image sensing element from the optical system; and
a drive control means for driving the first image sensing element based on field signals sequentially repeating ODD field period and EVEN field period, driving the second image sensing element based on field signals having a different phase than the first image sensing element, and controlling the operation of the first shutter means and second shutter means so as to expose with light from the optical system an image sensing element having the ODD field period among the first and second image sensing elements.

9. The particle image capturing apparatus of claim 8, wherein the drive control means drives the second image sensing element based on a field signal having a phase which is reverse that of the first image sensing element.

10. The particle image capturing apparatus of claim 8, wherein the light source emits light at predetermined time intervals, and the drive control means controls the first and second shutters so as to image the optical image of a particle in a suspension fluid with each emission of the light source.

11. The particle image capturing apparatus of claim 8, further comprising a particle detector for detecting particle in the particle suspension fluid, and a light emission control means for controlling the emission of the light source based on the detection of particles by the particle detector, wherein the drive control means controls the first and second shutters so as to image the optical image of a detected particle.

12. The particle image capturing apparatus of claim 8, further comprising an analyzing means for analyzing particles based on a captured particle image.

13. The particle image capturing apparatus of claim 8, wherein the analyzing means for analyzing the particles based on a captured particle image determines the characteristics parameters of the particle based on the particle image.

14. The particle image capturing apparatus of claim 8, wherein the first and second shutters are electronic shutters.

15. A particle image capturing apparatus comprising:
a first two-dimensional image sensing element;
a second two-dimensional image sensing element;
an optical system for forming identical optical images of the particle on the first and second image sensing elements; and
a drive control means for driving the first and second image sensing elements with different timings, and controlling the operation of electronic shutters of the respective image sensing elements so as to expose one or another of the first or second image sensing elements.

16. The particle image capturing apparatus of claim 15, further comprising a flow cell for forming a flow of the particle suspension, and a light source for irradiating particle in the particle suspension flow with light.

17. The particle image capturing apparatus of claim 16, wherein the light source emits light at predetermined time intervals, and the drive control means controls the operation of the electronic shutters of the first and second image sensing elements so as to form an optical image of particles in a suspension fluid with each emission of the light source.

18. The particle image capturing apparatus of claim 16, further comprising a particle detector for detecting particles in the flow of a particle suspension fluid, and a light emission control means for controlling the emission of the light source based on the detection of particles by the particle detector, wherein the drive control means controls the operation of the electronic shutters of the first and second image sensing elements so as to form an optical image of the detected particle.

19. The particle image capturing apparatus of claim 15, further comprising an analyzing means for analyzing particles based on the captured particle image.

20. The particle image capturing apparatus of claim 19, wherein the analyzing means for analyzing the particles based on the captured particle image determines the characteristics parameters of the particle based on the particle image.
